(19) United States
(12) Patent Application Publication
(10) Pub. No.: US 2009/0314214 A1
(43) Pub. Date: Dec. 24, 2009

(54) Quick disposable cat litter

(76) Inventor: Sidney Herbert Miller, (US)

Correspondence Address: S. H. MILLER, 850 E. LOUTHER ST, CARLISLE, PA, 17013, US

(21) Appl. No.: 12/455,850

(22) Filed: Jun. 8, 2009

Related U.S. Application Data
(60) Provisional application No. 61/131,294, filed on Jun. 9, 2008.

(51) Int. Cl. A01K 29/00; G09F 7/00

(52) U.S. Cl. 119/165; 119/171; 40/1

(57) ABSTRACT

A quick disposable cat litter that is bonded to a backing. In another version the cat litter and backing are molded as one piece. In a third version the cat defecates on a picture of cat litter.

### REFERENCE TO RELATED APPLICATIONS

This application was preceded by Provisional Patent application Ser. No. 61/131,294 filed Jun. 9, 2008 by Sidney H. Miller and titled QUICK DISPOSABLE CAT LITTER.

### FIELD OF INVENTION

A quick cat litter system where the litter or simulated litter is attached to a backing.

### FEDERALLY SPONSERED RESEARCH

Unknown

### BACKGROUND—FIELD OF INVENTION

A. Problems Solved

The standard cat litter systems are messy and unsanitary. In this system the cat litter or simulated cat litter is permanently held on a permeable or impermeable backing. This system has the following advantages:

Sanitary, eliminates tracking, reduces odors, economical, dust free and convenient.

B. Prior Art

U.S. Pat. No. 3,827,401 disclosed the use of an absorbent pad.

U.S. Pat. No. 3,752,121 recommends a layer of artificial grass.

U.S. Pat. No. 5,630,377 shows an assembly of grass like material.

U.S. Pat. No. 6,405,678 B2 prefers pulp fibers.

C. Tests

In side by side tests, we have found my cat prefers the cat litters made by ARM & HAMMER, CRYSTALS, EVERCLEAN, EXTRUSION, FRESH STEP, SCOOP-AWAY, TIDY CAT, etc. attached to a backing.

### SUMMARY OF THE INVENTION

This invention is made from a sheet of film, permeable or impermeable, with a layer of cat litter attached.

In another design, the cat litter shape is molded with film, foil, resin, or cellulose to simulate cat litter.

We have also found that a picture of cat litter attached to a plastic film is workable.

### OBJECTS

The main purpose here is economy and convenience. Other advantages are sanitation, cleanliness, odor reduction, dustless and eliminate tracking.

### DESCRIPTION OF DRAWINGS

FIG. 1 is a plan view of the cat litter bonded to backing.

FIG. 2 is a sectional view along lines 2-2 of FIG. 1.

FIG. 3 is a plan view of molded simulated cat litter.

FIG. 4 is a sectional along lines 4-4 of FIG. 3.

### FIRST EMBODIMENT

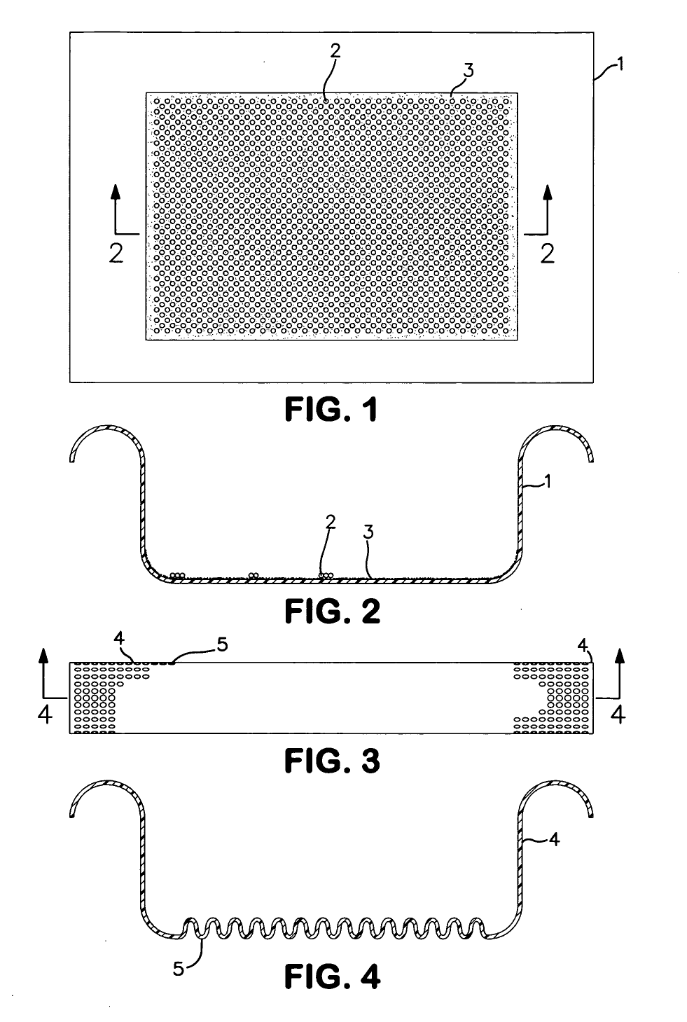

### FIGS. 1 and 2

The first embodiment shown in FIGS. 1 and 2 with backing 1 and cat littler 2 attached to avoid movement.

### SECOND EMBODIMENT

### FIGS. 3 and 4

The second embodiment with the molded part 4 and the simulated cat litter 5 molded as one piece as shown.

What is claimed and hoped:

1. A sheet of organic or inorganic film with attached cat litter

2. A sheet of organic or inorganic film molded in the form of cat litter.

3. A picture of cat litter on organic or inorganic film.
